(19) United States
(12) Patent Application Publication
(10) Pub. No.: US 2014/0285886 A1
(43) Pub. Date: Sep. 25, 2014

(54) STEREOSCOPIC VIEWER

(71) Applicant: Jeremy J. DePalma, Seattle, WA (US)

(72) Inventor: Jeremy J. DePalma, Seattle, WA (US)

(21) Appl. No.: 14/355,832

(22) PCT Filed: Nov. 2, 2012
(86) PCT No.: PCT/US12/63295

§ 371 Date: May 1, 2014

Related U.S. Application Data
(60) Provisional application No. 61/554,505, filed on Nov. 2, 2011.

(51) Int. Cl. G02B 27/22

(52) U.S. Cl. CPC G02B 27/2242
USPC 359/466

(57) ABSTRACT

Embodiments of a stereoscopic viewer including first and second eyepieces spaced apart from each other at a distances substantially corresponding to the distance between human eyes. Each eyepiece includes a first window that is planar, optically transparent, and has a first thickness and a first refractive index, a second window that is generally planar, optically transparent, and has a second thickness and a second refractive index, the second window positioned opposite the first window at an optical vertex angle relative to the first window; and a fluid reservoir formed between the first window and a second window and bounded by at least the first window and the second window. Other embodiments are disclosed and claimed.

### CROSS-REFERENCE TO RELATED APPLICATIONS

This application claims priority under Article 8 of the Patent Cooperation Treaty (PCT) to U.S. Provisional Patent Application No. 61/554,505, filed 2 Nov. 2011, the contents of which are hereby incorporated by reference in their entirety.

### TECHNICAL FIELD

The disclosed embodiments relate generally to stereoscopic viewers, and in particular to stereoscopic viewers including eyepieces that can be filled with water or other fluids for viewing stereo image pairs.

### BACKGROUND

A stereogram, or stereoscopic image pair, is an adjacent pair of seemingly identical images of equal outer dimensions. When a user views the image pair together, he or she sees the image pair as a single three-dimensional or stereoscopic image. Stereo-image pairs can be found in print media such as books, banners, posters, magazines, or newspaper, and can also be found in electronic form, displayed on-screen with computer equipment such as a laptop computer, home personal computer, portable electronic device, or flat-screen television. Moreover, the individual images can be still images such as photographic, print media, or electronically displayed still images, or they can be displayed as stereo movies, or video image sequences, where left-eye and right-eye perspective video frames are played simultaneously, such as contemporary video media compositions of stereoscopic 3-D short movie productions, video productions and/or animated sequences commonly found on the internet.

A stereo-image pair includes two adjacent images: a left-eye-perspective image and a right-eye-perspective image. The two images appear identical, but are not: the left-eye-perspective image represents how the left eye will see a scene, while the right-eye-perspective image represents how the right eye will see the very same scene. This means that the right-eye-perspective image of the scene is photographed, or captured from a virtual environment using computer software, from a different location that is generally within inches of the location from which the left-eye-perspective image was photographed or captured.

FIGS. 1A-1B illustrate how the individual images in a stereo-image pair can be placed adjacent to each other. After the individual images are captured, they can be positioned in a parallel arrangement of images or in a cross-arrangement of images to form the stereo-image pair. FIG. 1A illustrates a parallel arrangement of images, in which the left-eye-perspective image occupies the left half of the image pair, while the right-eye-perspective image occupies the right-half of the same image pair.

The parallel stereo-image pair can be viewed unaided by any optical device, but it requires some practice and is quite difficult. The person viewing the image pair must capture the right-eye-perspective image with the right eye, and the left-eye-perspective image with the left-eye, but this requires the use of a somewhat arduous method of focusing the eyes beyond the plane of the images until a central 3-dimensional image comes into focus.

FIG. 1B illustrates a cross-arrangement of images, in which the right-eye-perspective image occupies the left half of the image pair while the left-eye-perspective image occupies the right half of the same image pair. This arrangement is commonly used for viewing contemporary print media and electronic media such as stereoscopic 3-D short movie productions, video productions or animated sequences, commonly found on the internet. The cross-arranged stereo image pair can be viewed without any stereoscopic viewing device using a technique known as cross-viewing, but the technique requires some practice and is quite difficult. The person viewing the image pair must capture the right-eye-perspective image with the left eye, and the left-eye-perspective image with the right eye, but it requires the use of a somewhat arduous method of cross-focusing the eyes towards the intended images until a central three-dimensional image comes into focus.

Various types of glass or plastic prism-style viewing devices have been available for viewing stereoscopic-image pairs but have various disadvantages due to their construction.

### BRIEF DESCRIPTION OF THE DRAWINGS

Non-limiting and non-exhaustive embodiments are described with reference to the following figures, wherein like reference numerals refer to like parts throughout the various views unless otherwise specified. Figures are not to scale unless specifically designated as being to scale.

FIGS. 1A-1B are schematic drawings of embodiments of stereo-image pairs.

FIGS. 2A-2B are schematic drawings of embodiments of stereoscopic viewers for viewing a stereo-image pair.

FIG. 3 is a cross-sectional view of an embodiment of an eyepiece for a stereoscopic viewer.

FIGS. 4A-4F are drawings illustrating cross-sectional shapes of various embodiments of eyepieces for a stereoscopic viewer.

FIGS. 5A-5B are perspective drawings illustrating an embodiment of a stereoscopic eyepiece that can be filled with fluid.

FIGS. 6A-6B are a perspective view and a plan view, respectively, of an embodiment of a stereoscopic viewer.

FIGS. 7A-7B are a perspective view and a plan view, respectively, of another embodiment of stereoscopic viewer.

FIGS. 8A-8B are perspective drawings of embodiments of a single-reservoir eyepiece pair for a stereoscopic viewer.

FIGS. 9A-9B are a perspective view and a plan view, respectively, of another embodiment of a stereoscopic viewer.

FIGS. 10A-10B are perspective drawings of an embodiment of stereoscopic viewing glasses.

FIGS. 11A-11B are perspective drawings of an embodiment of a single-reservoir eyepiece pair for a stereoscopic viewer.

FIGS. 12A-12B are a perspective view and a plan view, respectively, of another embodiment of a stereoscopic viewer.

FIGS. 13A-13B are perspective views of another embodiment of a stereoscopic viewer.

FIGS. 14A-14B are perspective views of another embodiment of a stereoscopic viewer.

FIG. 14C is a drawing of an embodiment of the operation of the viewer shown in FIG. 14B.

FIG. 15 is a drawing showing numerous combinations of cross-sections of individual eyepieces in an eyepiece pair.

FIGS. 16A-16C are a perspective view and two sectional views, taken along section lines B-B and C-C in FIG. 16A, of another embodiment of a stereoscopic viewer.

FIG. 17 is a schematic drawing illustrating an embodiment of the operation of the stereoscopic viewer of FIGS. 16A-16C.

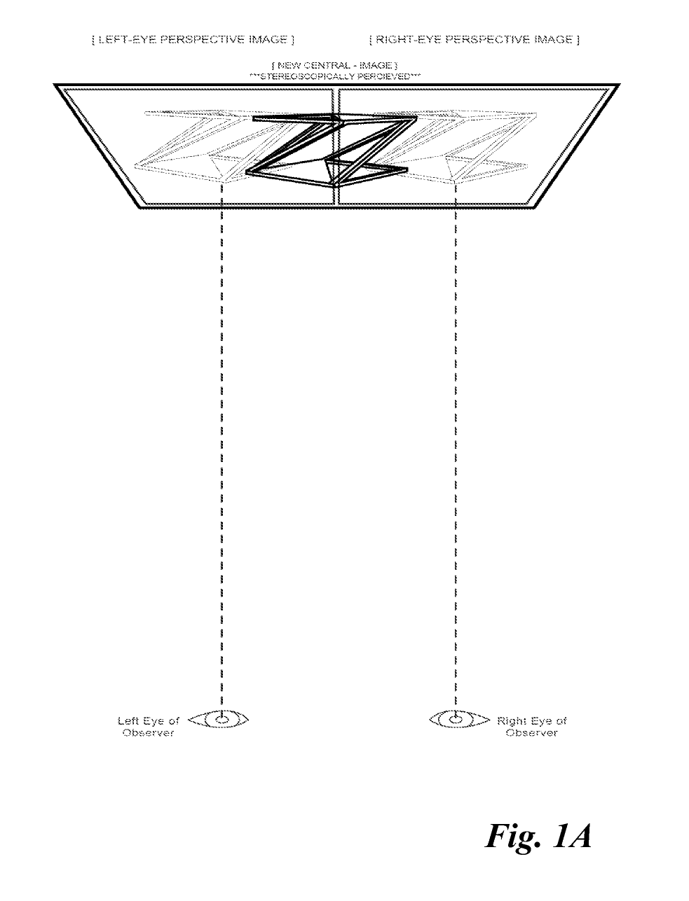

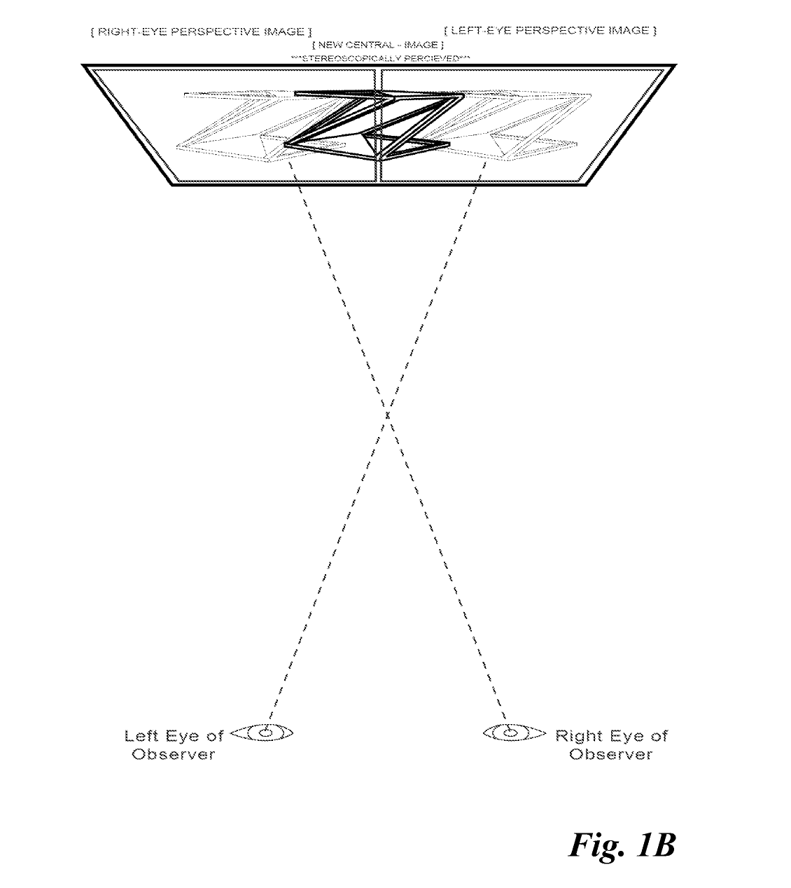

### DETAILED DESCRIPTION OF THE ILLUSTRATED EMBODIMENTS

Embodiments of an apparatus, method and system for stereoscopic viewing are described. Numerous specific details are described to provide a thorough understanding of embodiments of the invention, but one skilled in the relevant art will recognize that the invention can be practiced without one or more of the specific details, or with other methods, components, materials, etc. In some instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one described embodiment. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

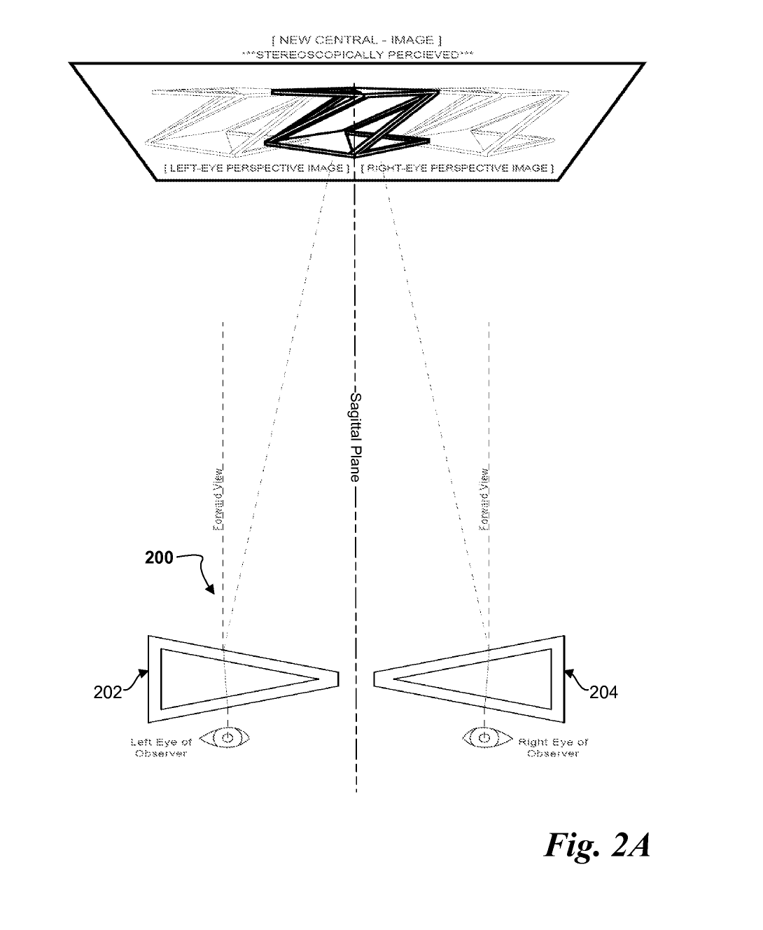

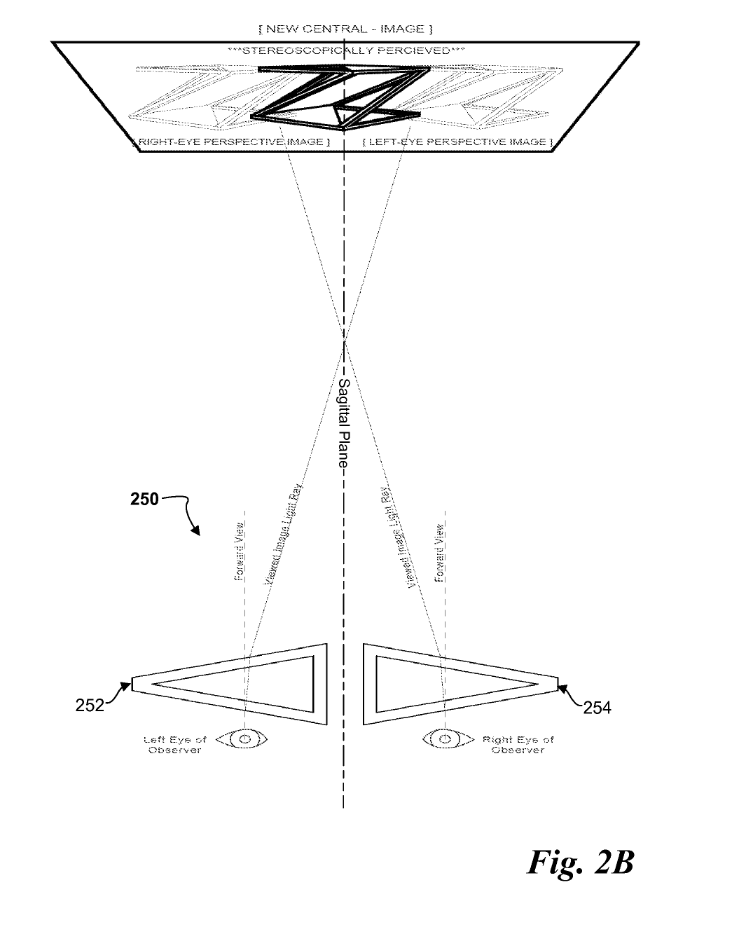

FIGS. 2A-2B schematically illustrate embodiments of stereoscopic viewers. FIG. 2A illustrates an embodiment of a stereoscopic viewer 200 for viewing a parallel arrangement of stereo-images. Viewer 200 includes a pair of eyepieces: a left eyepiece 202 that can be positioned in front of a user's left eye, and a right eyepiece 204 that can be positioned in front of a user's right eye. In the illustrated embodiment eyepieces 202 and 204 are fluid-filled prisms of triangular cross-section but, as further described below, other viewer embodiments can have differently-shaped and configured eyepieces. Both left eyepiece 202 and right eyepiece 204 have an optical vertex that points toward the sagittal plane. The sagittal plane is an imaginary plane that divides the human anatomy into substantially equal left and right halves; as such, the sagittal plane passes through the middle of the nose and roughly halfway between the eyes. When a user looks at a parallel stereo-image pair through eyepieces 202 and 204, the user does not perceive that there are two separate images, but rather perceives a single centrally-located image that appears three-dimensional—that is, stereoscopic.

FIG. 2B illustrates another embodiment of a viewer 250 for viewing a cross-arrangement of images. Viewer 250 includes a left eyepiece 252 that can be positioned in front of a user's left eye and a right eyepiece 254 that can be positioned in front of a user's right eye. As in viewer 200, in viewer 250 left eyepiece 252 and right eyepiece 254 are both fluid-filled prisms but can be other configurations in other embodiments. The primary difference between viewer 200 and viewer 250 is that in viewer 250 the optical vertex of the left eyepiece 252 and the optical vertex of the right eyepiece 254 point away from the sagittal plane when positioned in front of the eyes of a user—that is, the eyepieces point away from each other. When a user views a cross-arrangement stereo-image pair through eyepieces 252 and 254, the user does not perceive that there are two separate images but rather perceives a single centrally-located image that appears three-dimensional—that is, stereoscopic.

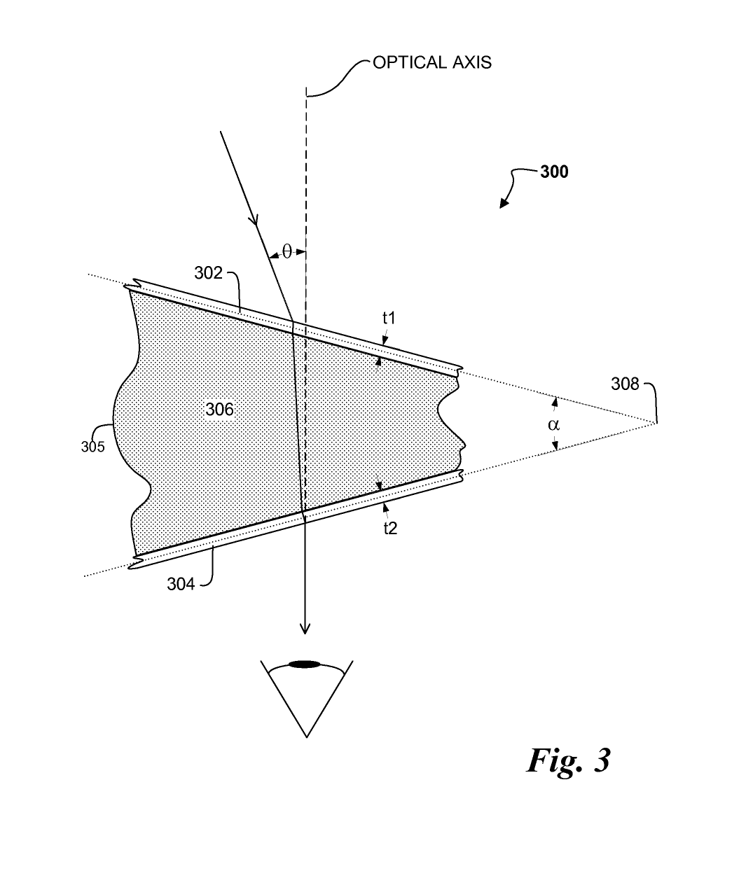

FIG. 3 schematically illustrates an embodiment of an eyepiece 300. Eyepiece 300 includes a first substantially planar optically transparent window 302 of substantially uniform thickness t1 and refractive index n1, as well as a second substantially planar and optically transparent window 304 of substantially uniform thickness t2 and refractive index n2. In one embodiment thicknesses t1 and t2 can be equal, but in other embodiments they need not be. Similarly, in one embodiment refractive indices n1 and n2 can be equal, but in other embodiments they need not be. In different embodiments, refractive indices n1 and/or n2 can have values between 1.0 and 1.6. In one embodiment, first window 302 and second window 304 can be colorless, but in other embodiments one or both of the first and second windows can be colored. In still other embodiments, the first and second window can have different colors.

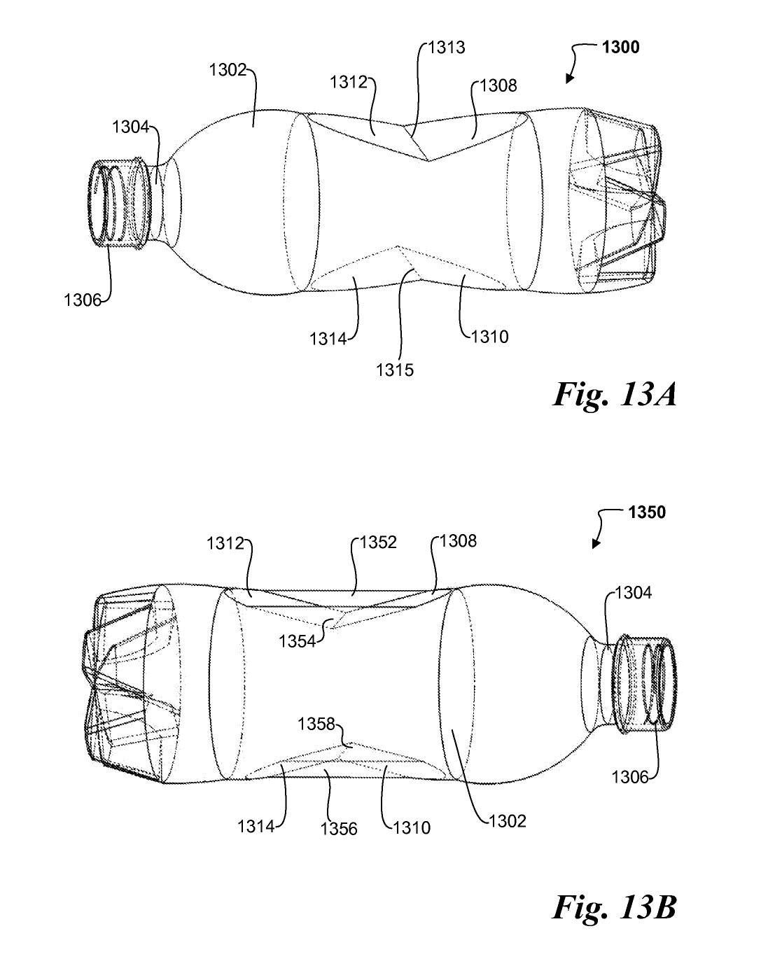

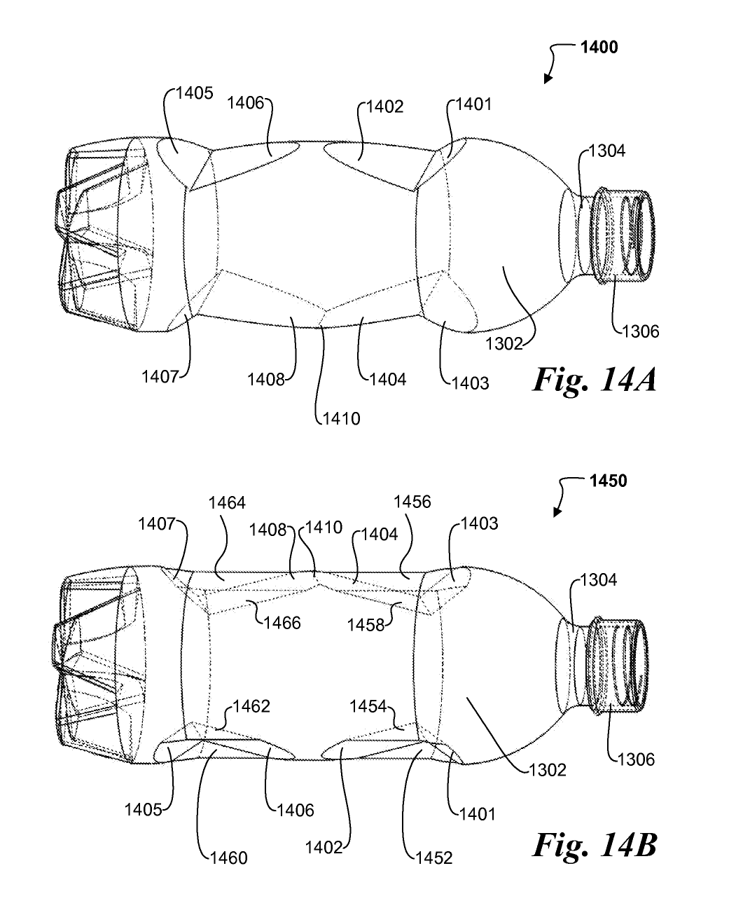

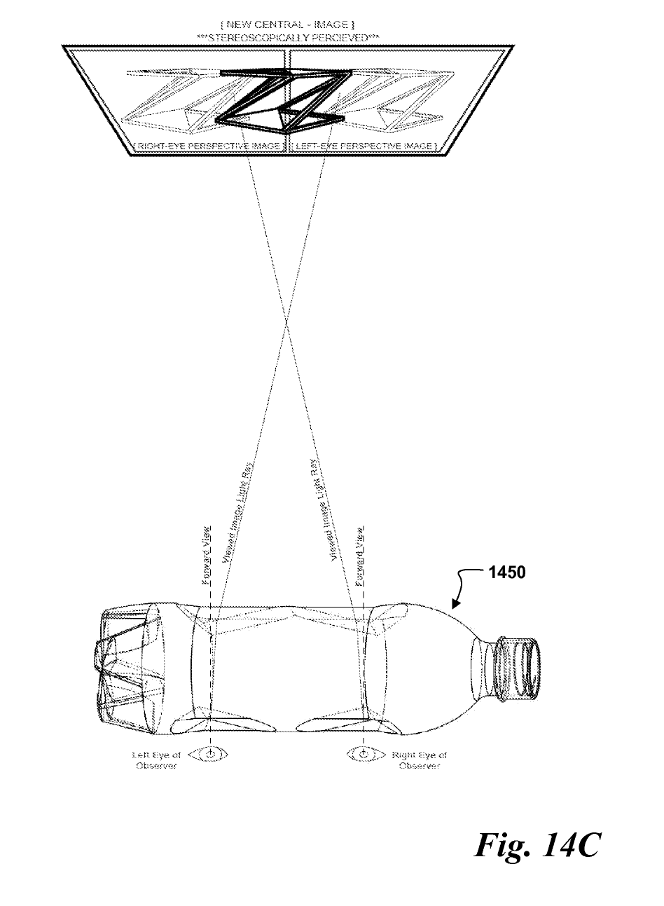

In one embodiment, one or both of a first window 302 and second window 304 can be made of optical-grade acrylic, but in other embodiments one or both of these windows can be made of other materials such as polycarbonate, polystyrene, polyethylene terephthalate (PET), glass, or some other optically transparent material. In an embodiment in which first window 302 and second window 304 are made of cast acrylic, t1 and t2 can be between 0.75 mm and 5.0 mm. In another acrylic embodiment, t1 and t2 can be 3 mm. In an embodiment in which one or both of windows 302 and 304 are made of polyethylene terephthalate (PET) (see, e.g., FIGS. 13-14), thicknesses up to 1.0 mm can be used. In another embodiment, thickness t1 and t2 of 0.3175 mm±0.25 mm can be used.

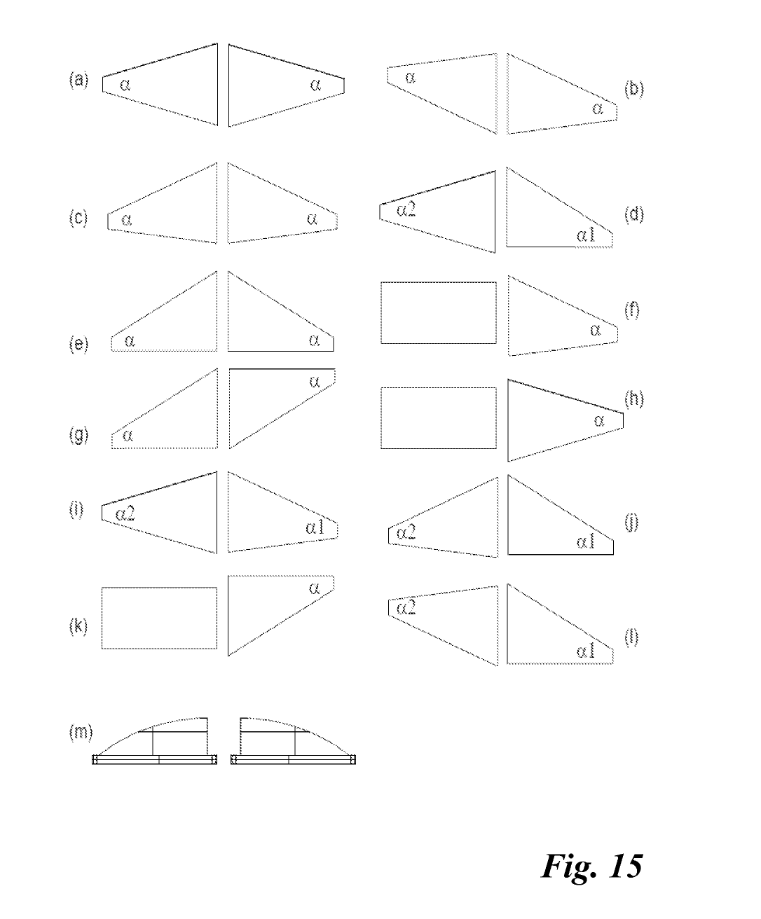

Although described as substantially planar, first window 302 and/or second window 304 need not be perfectly flat. In some embodiments, windows 302 and/or 304 can include a small to moderate convex curvature caused by fluid-pressure and/or manufacturing artifacts, resulting in small to moderate magnification in addition to stereoscopic viewing, similar or to a lesser degree than that of embodiment (m) shown in FIG. 15, where magnification is caused by intended convex curvature to one, or both viewing windows for magnification in-addition to stereoscopic viewing. In other embodiments, windows 302 and/or 304 can include a small to moderate concave curvature caused by excess exterior-pressure and/or manufacturing artifacts, resulting in small to moderate demagnification in-addition to stereoscopic viewing.

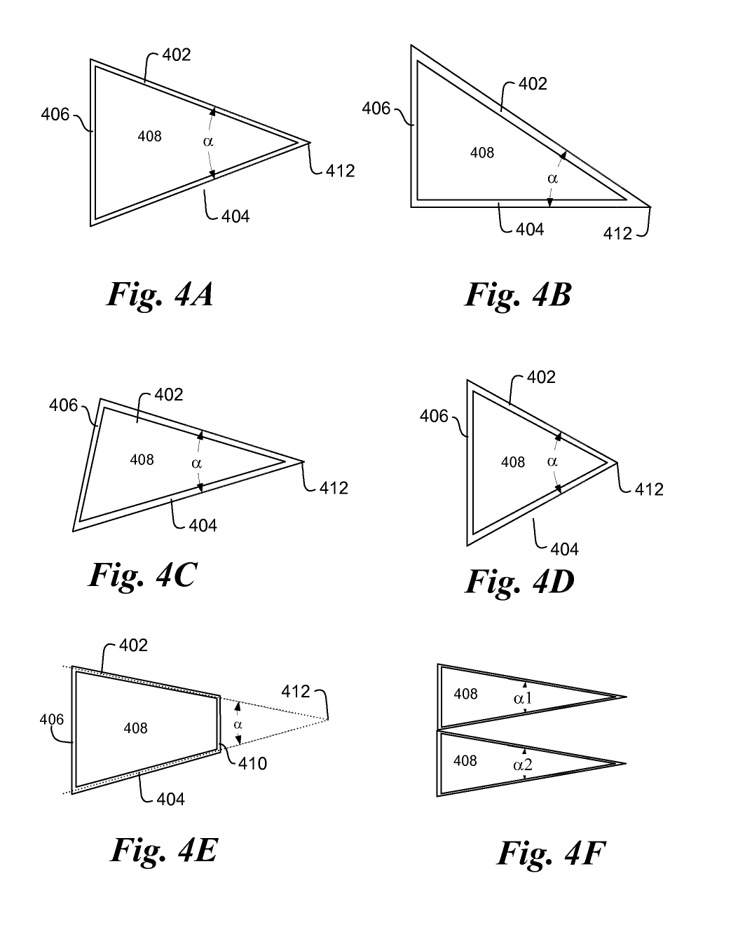

First window 302 and second window 304 are positioned at an angle α relative to each other, such that the planes of the windows and/or the windows themselves form an optical vertex 308. As used herein, the term “optical vertex” means an apparent vertex in cases where the first and second windows do not physically intersect, as shown in FIGS. 3 and 4E, or an actual vertex in cases where the first and second windows physically intersect, as shown in the embodiment of FIGS. 4A-4D. Angle α is referred to herein as the optical vertex angle. In one embodiment, α can be between 12° and 42°, but in another embodiment α can be between 22° and 32°. In yet another embodiment α can be 27°.

Between first window 302 and second window 304 is formed a fluid reservoir 305. How the fluid reservoir is formed between windows 302 and 304 is arbitrary, meaning that one or more additional elements of arbitrary shape can be coupled to windows 302 and 304 to form a closed volume that will form fluid reservoir 305. An optically transparent fluid 306 having refractive index n3 can be contained in the fluid reservoir. In one embodiment, fluid 306 can be water (n3=1.33, or 1.333), but in other embodiments fluid 306 can be any optically transparent fluid; examples of fluids include oils, alcohols, other pure liquids, solutions, carbonated liquids, liquids including dissolved gases, high-viscosity liquids such as syrups or very high-viscosity liquids such as gels. The value of refractive index n3 will depend on the optically transparent fluid used, but in various embodiments n3 can have values between 1.15 and 1.45. In other embodiments, n3 can have values between 1.20 and 1.40. In one embodiment fluid 306 can be colorless, but in other embodiments fluid 306 can have color.

In operation of eyepiece 300 when it is filled with fluid 306, a light ray from an image is incident on first window 302 at an angle θ relative to an optical axis of the eyepiece. The incident light ray is refracted at the surface of window 302 and then again at the interface between window 302 and fluid 306. The light ray travels through fluid 306 until it reaches second window 304, where it is again refracted at the interface between window 304 and fluid 306. The light ray travels through window 304 until it reaches the window-air interface, where it is again refracted such that emerges from the second window in the direction of the optical axis and is then directed to a user's eye. In some embodiments of eyepiece 300, the net change in direction θ of the incident light ray from its input to the eyepiece to at output of the eyepiece is all induced by refraction in fluid 306 because the refraction in windows 302 and 304 cancel each other out.

FIGS. 4A-4E illustrate specific embodiments of cross-sectional shapes of eyepieces. FIG. 4A illustrates a prismatic eyepiece whose cross-section is an isosceles triangle, with first window 402 and second window 404 being the equal sides of the isosceles triangle and meeting an angle α at actual optical vertex 412. A third side 406 is coupled to the other ends of first window 402 and 406 to form closed volume 408 within which fluid can be contained.

FIG. 4B illustrates an embodiment of a prismatic eyepiece whose cross-section is a right scalene triangle. A scalene triangle is a triangle whose sides are all of different lengths. First window 402 and second window 404 are positioned at optical vertex angle α relative to each other, and intersect each other at actual optical vertex 412. A third side 406 is coupled to the other end of first window 402 and second window 406 to form closed volume 408 within which fluid can be contained.

FIG. 4C illustrates an embodiment of a prismatic eyepiece whose cross-section is also a scalene triangle. The eyepiece of FIG. 4C differs from the eyepiece of FIG. 4B primarily in that the scalene triangle cross-section shown of FIG. 4C is not a right triangle. A third side 406 is coupled to the other ends of first window 402 and 406 to form closed volume 408 within which fluid can be contained.

FIG. 4D illustrates an embodiment of a prismatic eyepiece whose cross-section is an equilateral triangle—a triangle in which all sides are of equal length. In the eyepiece cross-section of FIG. 4D first window 42 second window 404 are positioned at an optical vertex angle α relative to each other and meet at actual optical vertex 412. A third side 406 is coupled to the other ends of first window 402 and 406 to form closed volume 408 within which fluid can be contained.

FIG. 4E illustrates an embodiment of a prismatic eyepiece whose cross-sectional shape is a trapezoid. First window 402 and second window 404 are positioned at optical vertex angle α relative to each other. In this embodiment, first window 402 and second window 404 do not physically intersect, but nonetheless their planes intersect at optical vertex 412, which in this case is an apparent vertex rather than an actual vertex. Additional sides 406 and 410 close the shape to form closed volume 408 within which fluid can be contained.

FIG. 4F illustrates an embodiment of a compound eyepiece, made by stacking two individual eyepieces. In the illustrated embodiment, the compound eyepiece is made by stacking one prismatic eyepiece of isosceles cross-section and optical vertex angle α1 with a second prismatic eyepiece of isosceles cross-section with optical vertex angle α2 in the same orientation (i.e., with the optical vertex pointing the same direction). In one embodiment α1 and α2 can be equal, but in other embodiments they need not be. In other embodiments, the individual eyepieces in the stack need not all have the same cross-section and/or need not be stacked in the same orientation. In still other embodiments more than two individual eyepieces can be stacked to achieve the desired optical effect.

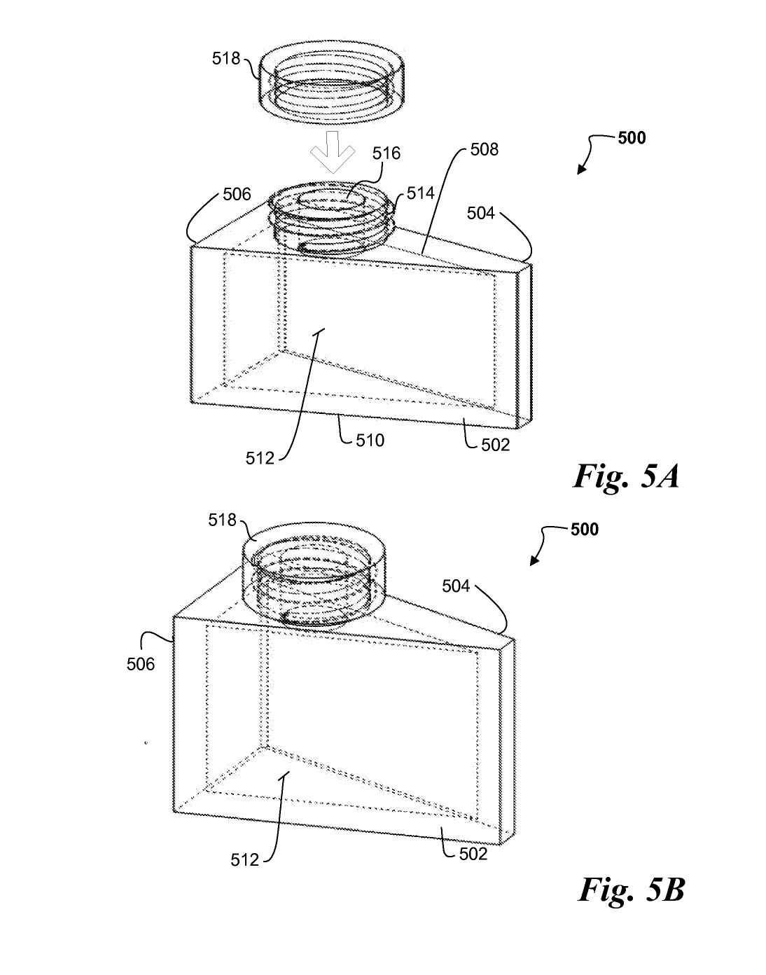

FIGS. 5A-5B together illustrate an embodiment of an eyepiece 500. Eyepiece 500 has the isosceles cross-section illustrated in FIG. 4A, but of course could be made with any cross-section that includes two windows and can contain a fluid within. Eyepiece 500 includes first window 502 and second window 504. Windows 502 and 504 meet on one end to form the optical vertex of the eyepiece. The other ends of windows 502 and 504 are joined to another panel 506. Top panel 508 and a bottom panel 510 close the shape to form an interior volume 512 the can then be filled with fluid. First window 502, second window 504, and all the other panels of eyepiece 500 can be made of the same materials and with the same dimensions and angles mentioned in connection with FIG. 3.

In the illustrated embodiment, eyepiece 500 includes a fill port 516 in top panel 508. Fill port 516 can be used to fill, empty, and refill fluid from interior volume 512. In the illustrated embodiment fill port 516 is threaded 514 so that it can engage with a cap 518 that can hermetically seal interior volume 512 to keep fluid from escaping when the interior volume is filled with fluid. In other embodiments, however, other types of fill ports and other embodiments of caps or plugs can be used. In still other embodiments, eyepiece 500 need not include a fill port at all, such that fluid can be permanently sealed inside interior volume 512.

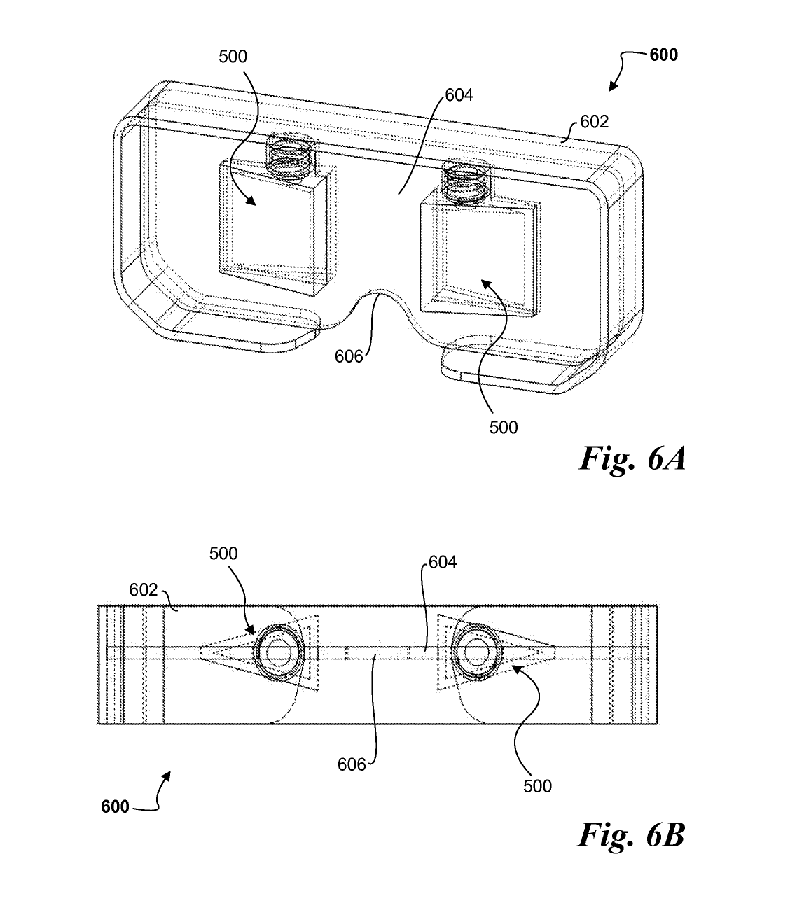

FIGS. 6A-6B together illustrate an embodiment of a stereoscopic viewer 600 that can be used to view a cross-arrangement of images. Viewer 600 includes a flat plate 604 around the perimeter of which is wrapped a frame 602. Flat plate 604 also includes a cutout 606 to accommodate the bridge of a user's nose. A pair of eyepieces 500 is supported in flat plate 604, spaced apart from each other at a distance roughly corresponding to the separation of a user's eyes. The orientation of eyepieces 500 is such that the optical vertex of each eyepiece 500 points away from the sagittal plane when positioned in front of the eyes of a user (i.e., the eyepieces point away from each other) meaning that viewer 600 can be used for viewing a cross-arrangement of images. Viewer 600 is a hand-held binocular-type viewer. In operation, a user can use his or her hands to hold frame 602 and raise the viewer 600 to his or her face to position eyepieces 500 in front of the eyes, and then view the cross-arrangement of images through the eyepieces. In other embodiments flat plate 604 can be replaced by a structure containing more than one flat plate, or by a molded housing of a voluminous shape and design so long as its utility is to hold eye-pieces for viewing firmly in place.

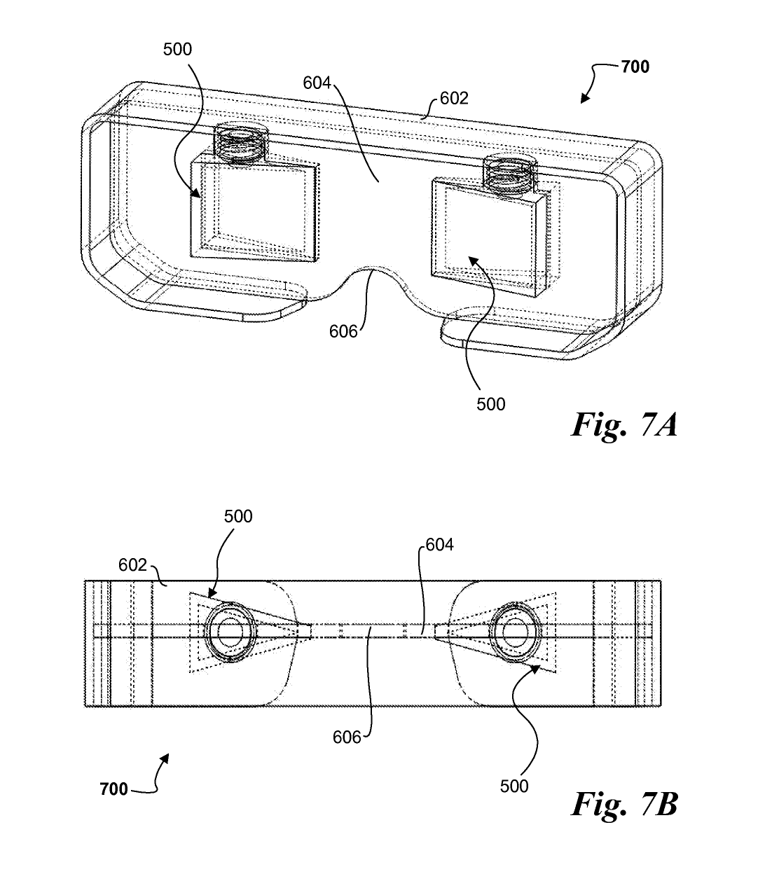

FIGS. 7A-7B illustrate another embodiment of a stereoscopic viewer 700 that can be used to view a parallel arrangement of images. Viewer 700 is in most respects similar to viewer 600. The primary difference is the orientation of eyepieces 500. In viewer 700, the optical vertex of each eyepiece 500 points toward the sagittal plane when positioned in front of the eyes of a user (i.e., the eyepieces point toward each other), meaning that viewer 700 can be used for viewing a parallel arrangement of images. In other embodiments flat-plate 604 can be replaced by a structure containing more than one flat-plate, or by a molded housing of a voluminous shape and design so long as its utility is to hold eye-pieces for viewing firmly in place.

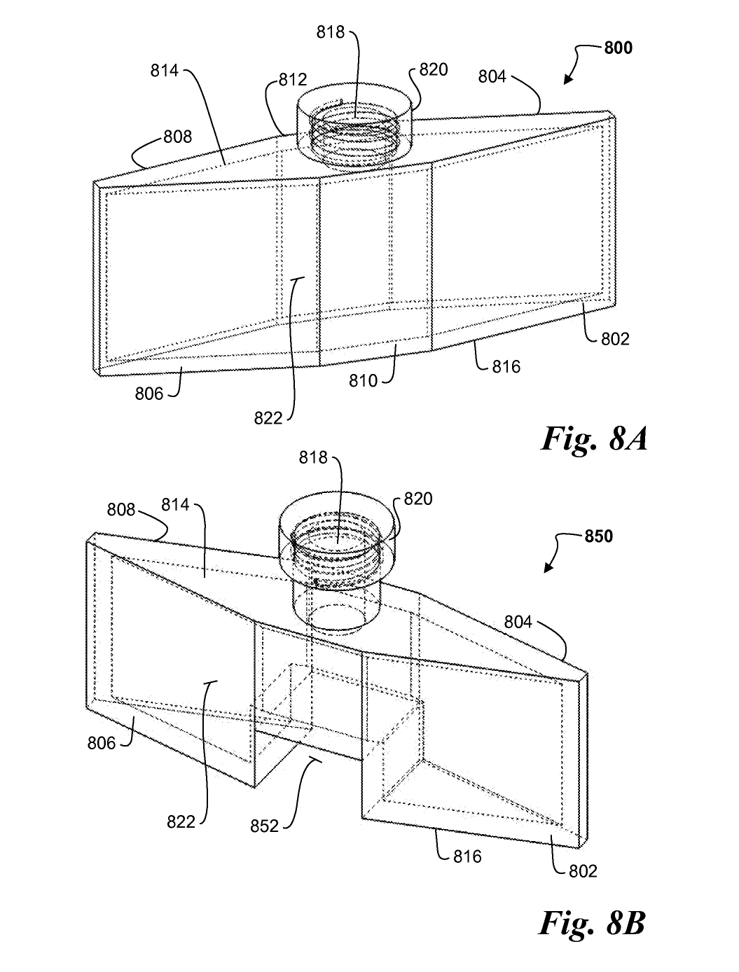

FIGS. 8A-8B illustrate embodiments of single-reservoir eyepiece pairs. These embodiments are referred to a single-reservoir eyepiece pairs because they form a pair of eyepieces using a single fluid reservoir. FIG. 8A illustrates a single reservoir eyepiece pair 800. Eyepiece pair 800 includes windows 802 and 804. One end of window 802 is coupled to an end of window 804 at an optical vertex, while the other end of window 802 is coupled to panel 810 and the other end of window 804 is coupled to panel 812. Eyepiece pair 800 also includes windows 806 and 808. One end of window 806 is coupled to an end of window 808 at an optical vertex, while the other end of window 808 is coupled to panel 812 and the other end of window 806 is coupled to panel 810. A bottom panel 816 is coupled to the edges of windows 802-808, panel 810 and panel 812. Similarly, a top panel 814 is coupled to the opposite edges of windows 802-808 and panels 810 and 812 to form closed volume 822. Top surface 814 includes a fill port 818 through which volume 822 can be filled, emptied, and refilled with fluid. In the illustrated embodiment, fill port 818 is threaded so that it engages with a cap 820 that can be screwed onto the fill port to seal fluid in interior volume 822 when it is filled with fluid.

In eyepiece pair 800, one eyepiece is formed by windows 802 and 804 together with fluid in enclosed in interior volume 822 when filled, while another eyepiece is formed by windows 806 and 808 together with the fluid in volume 822 when filled. The eyepieces are spaced apart at a distance substantially corresponding to the separation of a user's eyes. In the illustrated embodiment, the positioning of windows 802-804 and 806-808 is such that the eyepieces have an isosceles cross-section as shown in FIG. 4A, but in other embodiments the eyepieces could have different cross-sections. In the illustrated embodiment, the optical vertex of each eyepiece points away from the sagittal plane when positioned in front of the eyes of a user (i.e., the eyepieces point away from each other), so that eyepiece pair 800 can be used to view cross-arrangement stereoscopic image pairs.

In one embodiment of eyepiece pair 800, windows 802-808, as well as panels 810 and 812, top panel 814 and bottom panel 816 can all be made using any of the materials, dimensions, angles, and variations mentioned above in the discussion of FIG. 3, but in other embodiments all these elements need not be made of the same material. In one embodiment, for example, panels 810 and 812, as well as bottom panel 816 and top panel 814, need not be made of optically transparent material and can instead be made of a translucent or opaque material.

FIG. 8B illustrates another embodiment of a single-reservoir eyepiece pair 850. Eyepiece pair 850 is in most respects similar to single-reservoir eyepiece pair 800. The primary difference is that in eyepiece pair 815 bottom panel 816 and panels 810 and 812 are modified to create a void 852 to better accommodate a user's nose. In the illustrated embodiment, void 852 is rectangular, but in other embodiments void 852 could be rounded or otherwise to shaped to better accommodate a user's nose. Eyepiece pair 850 can be manufactured in the same way, and using the same materials, dimensions and angles, with the same variations, as eyepiece pair 800.

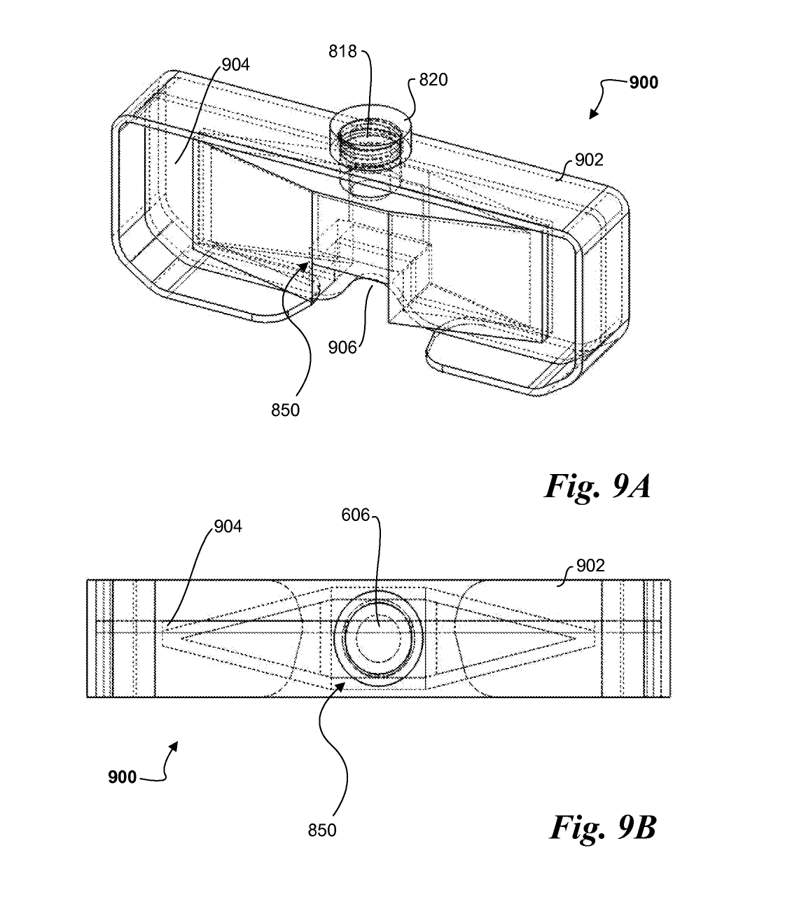

FIGS. 9A-9B together illustrate an embodiment of a stereoscopic viewer 900. Viewer 900 includes a flat plate 904 around the perimeter of which is wrapped a frame 902. Flat plate 904 also includes a cutout 906 to accommodate the bridge of a user's nose. A single-reservoir eyepiece pair 800 is supported in flat plate 904. The orientation of the individual eyepieces in eyepiece pair 800 is such that the optical vertex of each eyepiece points away from the sagittal plane when positioned in front of the eyes of a user (i.e., the eyepieces point away from each other), meaning that eyepiece pair 800, and hence viewer 900, can be used for viewing a cross-arrangement of images. Viewer 900 is a hand-held binocular-type viewer. Fill port 818 extends through the top surface of frame 902 so that eyepiece pair 850 can be filled, emptied, and re-filled. Cap 820 engages with fill port 818 to hermetically seal the fluid in the internal volume. In operation, a user can use his or her hands to hold frame 902 and raise the viewer 900 to his or her face to position the individual eyepieces in eyepiece pair 800 in front of the eyes and then view the stereo-image pair through the eyepieces. In other embodiments flat plate 904 can be replaced by a structure containing more than one flat plate, or by a molded housing of a voluminous shape and design so long as its utility is to hold eye-piece pair 850 firmly in place for viewing.

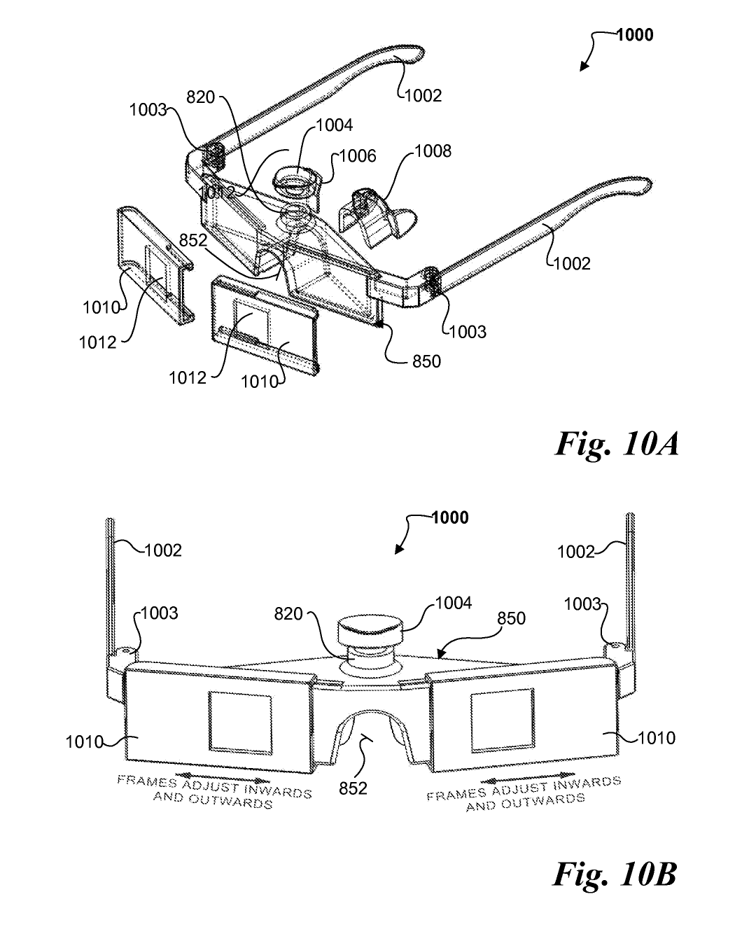

FIGS. 10A-10B together illustrate an embodiment of stereoscopic viewing glasses 1000. Stereoscopic viewing glasses 1000 include single-reservoir eyepiece pair 850, although other eyepieces can be used in other embodiments. Arms 1002 are attached via hinges 1003 to the sides of eyepiece pair 850 roughly at the optical vertices of the individual eyepieces. Arms 1002 are hinged so that they can be folded for compact storage, and are designed to engage with the user's ears to hold the glasses in place when positioned on the bridge of a user's nose.

A nose pad 1008 can be inserted into void 852 of the eyepiece pair 850 to increase user comfort when glasses 1000 are sitting on the bridge of a user's nose. In one embodiment, nose pad 1008 can be made of a soft, pliable material such as a gel or a foam. Fill port 820 is positioned on the top side of glasses 1000. A tightly-fitting cap 1004, with or without an interior plug, covers and seals fill port 820. A tether 1006 can attach cap 1004 to eyepiece pair 850 or to nose pad 1008, so that cap 1004 will be less likely to get lost during use. Another tightly-fitting cap embodiment can be in the form of an interior-plug only that fits snugly into its intended fill port.

A pair of opaque shades 1010 having viewing ports 1012 therein can optionally be positioned and mounted over the individual eyepieces of eyepiece pair 850. Viewing ports 1012 can be simple holes cut into shades 1010, or can have a colorless or colored transparent material covering them. In one embodiment, shades 1010 can be moved laterally inward and outward (substantially toward and away from the sagittal plane when glasses 1000 are positioned in front of the eyes of a user), so that a user of glasses 1000 can adjust his or her view of the stereoscopic images. In other embodiments, shades 1010 can be stationary. In still other embodiments, shades 1010 can be colored to make the glasses 1000 more colorful. In one embodiment in which shades 1010 are colored, both individual shades in the pair of shades 1010 can be of the same color, but in other embodiments the individual shades can have different colors.

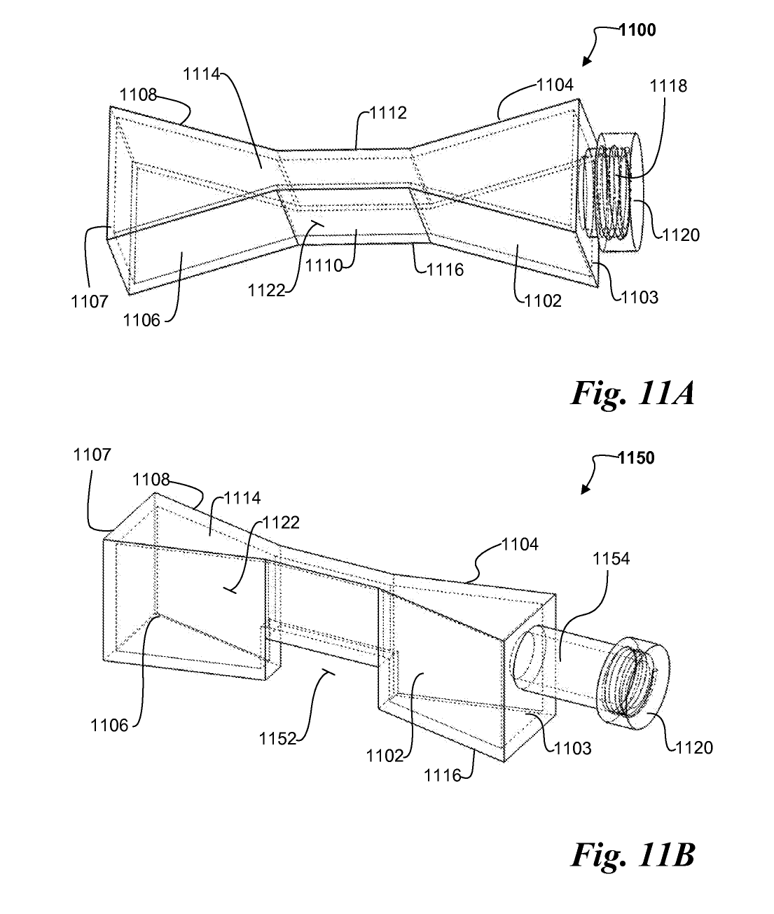

FIGS. 11A-11B illustrate other embodiments of single-reservoir eyepiece pairs. FIG. 11A illustrates a single-reservoir eyepiece pair 1100. Eyepiece pair 1100 includes windows 1102 and 1104. One end of window 1102 is coupled to an end panel 1103, while the other end is coupled to panel 1110. Similarly, one end of window 1104 is coupled to end panel 1103 and the other end is coupled to panel 1112. Eyepiece pair 1100 also includes windows 1106 and 1108. One end of window 1106 is coupled to an end panel 1107, while the other end is coupled to panel 1110. Similarly, one end of window 1108 is coupled to end panel 1107 and the other end is coupled to panel 1112. A bottom panel 1116 and a top panel 1114 are both coupled to the edges of windows 1102-1108, panels 1110-1112, and end panels 1103 and 1107 to form a closed interior volume 1122. Side panel 1103 includes a fill port 1118 through which interior volume 1122 can be filled, emptied, and refilled with fluid. In the illustrated embodiment, fill port 1118 is threaded so that it engages with a cap 1120 that can be screwed onto the fill port to hermetically seal interior volume 822.

In eyepiece pair 1100, one individual eyepiece is formed by windows 1102 and 1104, as well as by fluid enclosed in interior volume 1122 when filled, while another individual eyepiece is formed by windows 1106 and 1108 and fluid in volume 822 when filled. The individual eyepieces are spaced apart at a distance substantially corresponding to the separation of a user's eyes. In the illustrated embodiment, the positioning of windows 1102-1104 and 1106-1108 are such that the eyepieces have the isosceles cross-section shown in FIG. 4A, but in other embodiments the individual eyepieces could have other cross-sections. In the illustrated embodiment, the optical vertex of each eyepiece points toward the sagittal plane when positioned in front of the eyes of a user (i.e., the eyepieces point toward each other), so that eyepiece pair 1100 can be used to view parallel-arrangement stereoscopic image pairs.

In one embodiment of eyepiece pair 1100, windows 1102-1108, as well as panels 1110 and 1112, end panels 1103 and 1107, and top panel 1114 and bottom panel 1116, can all be made using any of the materials, dimensions, angles and variations mentioned above in the discussion of FIG. 3, but in other embodiments all these elements need not be made of the same material. In one embodiment, for example, panels 1110 and 1112, as well as bottom panel 1116, top panel 1114, and end panels 1103 and 1107, need not be made of optically transparent material but can instead be made of a translucent or opaque material.

FIG. 11B illustrates another embodiment of a single-reservoir eyepiece pair 1150. Eyepiece pair 1150 is in most respects similar to single-reservoir eyepiece pair 1100. The primary difference is that in eyepiece pair 1150 bottom panel 1116 and panels 1110 and 1112 are modified to create a void 1152 to better accommodate a user's nose. In the illustrated embodiment, void 1152 is rectangular, but in other embodiments void 1152 could be rounded or otherwise to shaped to better accommodate users knows. Eyepiece pair 1150 can be manufactured in the same way, and using the same materials, as eyepiece pair 1100.

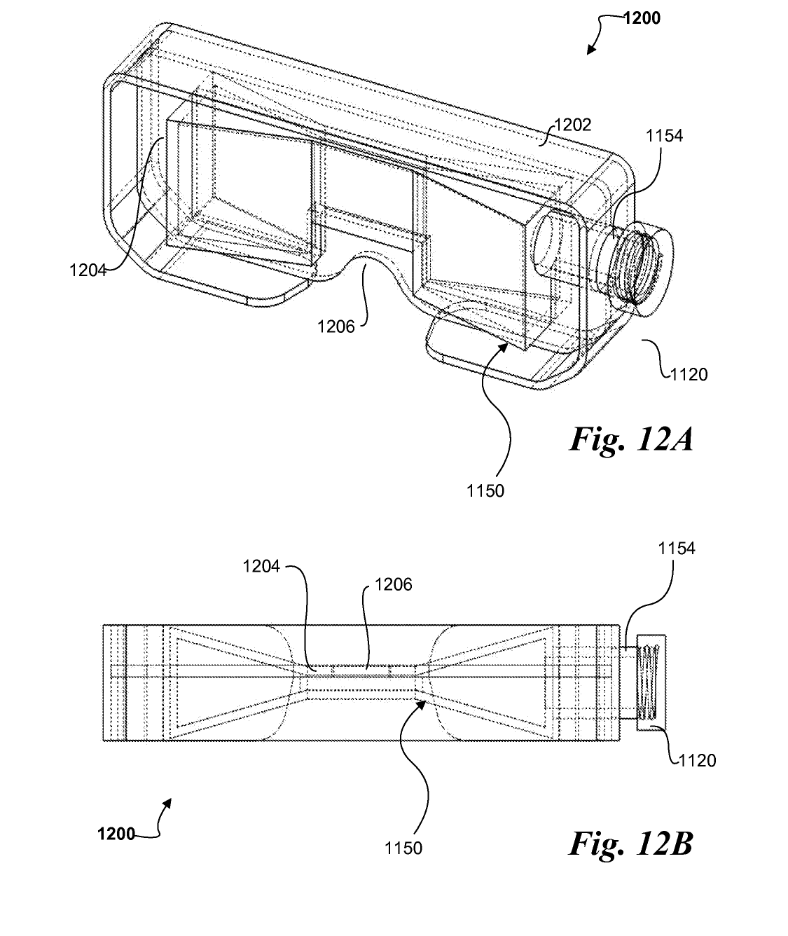

FIGS. 12A-12B together illustrate an embodiment of a stereoscopic viewer 1200. Viewer 1200 includes a flat plate 1204 around the perimeter of which is wrapped a frame 1202. Flat plate 1204 also includes a cutout 1206 to accommodate the bridge of a user's nose. A single-reservoir eyepiece pair 1150 is supported in flat plate 1204. Fill port 1154 extends through a sidewall of frame 1202 so that the eyepiece pair 1150 can be filled, emptied, and refilled with fluid. The orientation of the individual eyepieces in eyepiece pair 1150 is such that the optical vertex of each eyepiece points toward the sagittal plane when positioned in front of the eyes of a user (i.e., the eyepieces point toward each other), meaning that eyepiece pair 1150, and hence viewer 1200, can be used for viewing a parallel arrangement of images. Viewer 1200 is a hand-held binocular-type viewer. In operation, a user can use his or her hands to hold frame 1202 and raise the viewer 1200 to his or her face to position the individual eyepieces in eyepiece pair 1150 in front of the eyes and then view the stereo-image pair through the eyepieces. In other embodiments flat plate 1204 may be replaced by a structure containing more than one flat plate, or by a molded housing of a voluminous shape and design so long as it can hold eye-piece 1150 firmly in place for viewing.

FIGS. 13A-13B together illustrate two alternative embodiments of stereoscopic viewers. FIG. 13A illustrates a stereoscopic viewer 1300. Viewer 1300 includes a fluid container 1302 two having a fill port 1304 through which the interior volume of the fluid container can be filled, emptied, and refilled with fluid. A cap 1306 engages with fill port 1304 to hermetically seal the interior volume of fluid container 1302.

In one embodiment, fluid container 1302 can be an optically transparent container that is colorless or colored and can be used to contain any of the fluids, whether colorless or colored, described above in connection with FIG. 3. A specific and well-known embodiment of an optically transparent fluid container 1302 is the PET plastic containers in which soft drinks such as Sprite, Mountain Dew, Pepsi, and Orange Crush are often found. In other embodiments, fluid container 1302 can be translucent or opaque. In the illustrated embodiment, except for the ends of the container, the container is a right-circular cylinder (i.e., a cylinder with a circular cross-section). Other embodiments of container 1302 can have other shapes, such as a right oval cylinder, a right polygonal cylinder (e.g., a cylinder with a square or rectangular cross-section) or a polyhedron.

Fluid container 1302 includes a structure at the bottom that closes the container, a structure at the top that forms a fill port, and a sidewall that forms a substantially right-circular cylindrical portion. Two substantially planar and optically transparent windows 1308 and 1310 are formed in the sidewall on one side of the cylindrical portion, while two other planar and optically transparent windows 1312 and 1314 are formed in the sidewall on a diametrically opposed side of the cylinder. In the illustrated embodiment, windows 1308 and 1310, together with fluid that is between the windows when the fluid container is filled, form a first eyepiece, as illustrated in FIG. 3. Similarly, windows 1312 and 1314, together with fluid that is between the windows when the fluid container is filled, together form a second eyepiece.

In the illustrated embodiment, windows 1308 and 1312 are directly coupled to each other along seam 1313 while windows 1310 and 1314 are directly coupled to each other along seam 1315, but in other embodiments the windows need not be in direct contact with each other and there can be intervening structure between windows. In the illustrated orientation, the optical vertices of the individual eyepieces are in the direction of the sagittal plane when positioned in front of the eyes of a user (i.e., they point toward each other), meaning that the illustrated embodiment is suitable for viewing parallel arrangement stereo-image pairs.

In an embodiment in which fluid container 1302 is optically transparent, windows 1308-1314 can be directly molded into container 1302, for example during manufacture, but embodiments in which fluid container 1302 is translucent or opaque the optically transparent windows 1308-1314 can be formed by other techniques, such as selective molding or cutting out parts of the opaque or translucent bottle and replacing the cut-out parts with properly oriented optically transparent windows.

FIG. 13B illustrates an embodiment of a stereoscopic viewer 1350. Viewer 1350 is in most respects similar to viewer 1300. The primary difference is in how windows 1308, 1310, 1312, and 1314 are formed in the sidewall of fluid container 1302. In viewer 1350, windows 1308 and 1312 are formed in the sidewall in such a way that panels 1352 and 1354 are used to blend the windows into the sidewall. Similarly, windows 1310 and 1314 are formed in the sidewall in such a way that panels 1356 and 1358 are used to blend these two windows into the sidewall. In viewer 1300, windows 1308, 1310, 1312, and 1314 are formed in the sidewall of fluid container 1302 such that they need no further panels to blend them into the sidewall.

FIGS. 14A-14B together illustrate two other embodiments of a stereoscopic viewer. FIG. 14A illustrated a stereoscopic viewer 1400. Viewer 1400 is in most respects similar to viewer 1300. The primary difference between the viewers is that in viewer 1400 the windows used to form the eyepieces are formed in the side of container 1302 differently. In viewer 1400 substantially planar optically transparent windows 1402 and 1404 are formed in the sidewall on diametrically opposite sides of the container and, similarly, substantially planar optically transparent windows 1406 and 1408 are formed in the sidewall on diametrically opposite sides of container 1302. On one side of the container, windows 1402 and 1406 are not in direct contact with each other, but on the other side of the container windows 1404 and 1408 contact each other along seam 1410. Panels 1401 and 1403 are used to blend windows 1402 and 1404, respectively, into the sidewall of container 1302. Similarly, panels 1405 and 1407 and are used to blend windows 1406 and 1408, respectively, into the walls of fluid container 1302. In the illustrated orientation, the optical vertices of the individual eyepieces point away from the sagittal plane when positioned in front of the eyes of a user (i.e., they point away from each other) meaning that the illustrated embodiment is suitable for viewing cross-arrangements of stereo-image pairs.

FIG. 14B illustrates an embodiment of a stereoscopic viewer 1450. Viewer 1450 is in most respects similar to viewer 1400. The primary difference is in how the windows are formed in the sidewall of fluid container 1302. In viewer 1400, windows 1402, 1404, 1406, and 1408 are formed in the sidewall of fluid container 1302 such that they respectively need only panels 1401, 1403, 1405, and 1407 to blend them into the sidewall. By contrast, in viewer 1450, window 1402 is formed in the sidewall such that it is blended into the sidewall by panel 1401, as it is in viewer 1400, but also by additional panels 1452 and 1454. Window 1406 is formed in the sidewall such that it is blended into the sidewall by panel 1405, as it is in viewer 1400, but also by additional panels 1460 and 1462. Window 1404 is formed in the sidewall such that it is blended into the sidewall by panel 1403, as it is in viewer 1400, but also by additional panels 1456 and 1458. Finally, window 1408 is formed in the sidewall such that it is blended into the sidewall by panel 1407, as it is in viewer 1400, but also by additional panels 1464 and 1466. FIG. 14C illustrates an embodiment of the operation of viewer 1450, but viewer 1400 would function similarly.

FIG. 15 illustrates embodiments of combinations of cross-sectional shapes of the eyepieces that can be used in any of the previously-described viewer embodiments. In the previously-described viewers, both left and right eyepieces were of the same basic shape and optical vertex angle and were positioned symmetrically about the sagittal plane when positioned in front of the eyes of a user, such that they appear to be mirror images of each other about the sagittal plane. In other embodiments however, individual eyepieces in an eyepiece pair need not have the same basic shape, angle, or positioning, nor do they need to be mirror images of each other about the sagittal plane. In various embodiments shown in FIG. 15, the individual eyepieces in an eyepiece pair can be symmetrical and similarly or identically shaped (embodiments (a), (c) and (e)) or can be asymmetrical, with different shapes and/or different optical vertex angles (embodiments (b), (d), (f)-(l)). In still other embodiments, at least one window of each eyepiece can have a curved convex surface that can provide magnification in addition to stereoscopic viewing (embodiment (m)).

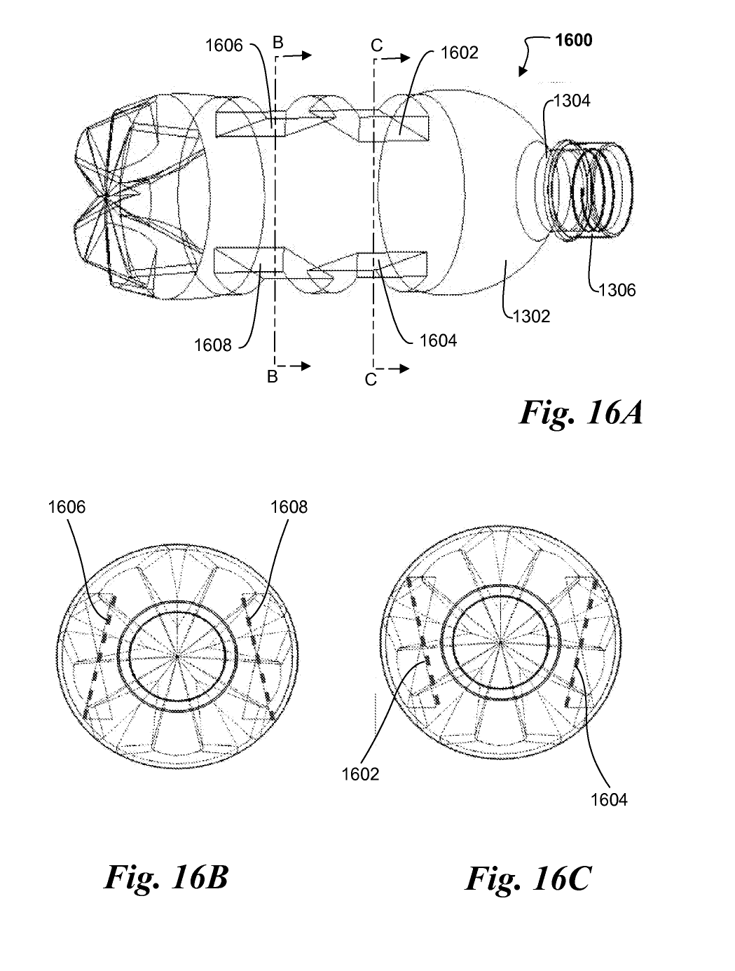

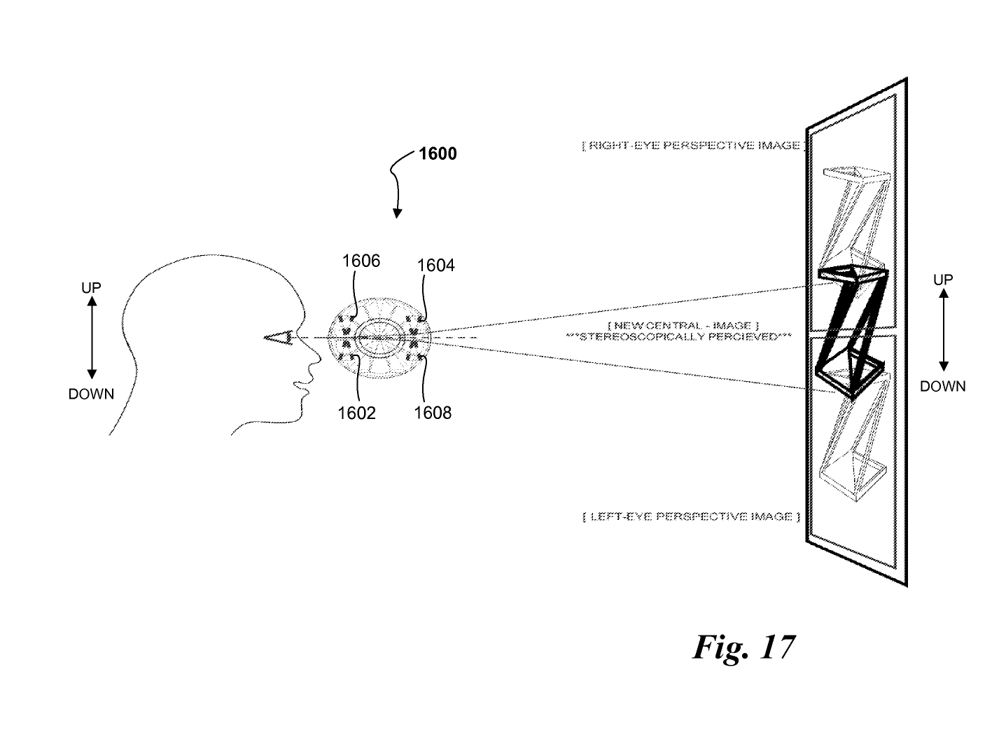

FIGS. 16A-16C together illustrate another embodiment of a stereoscopic viewer 1600; FIG. 16A is a perspective view, while FIGS. 16B-16C are sectional views taken along section lines B-B and C-C, respectively. Viewer 1600 is in most respects similar to viewers 1100, 1300, and 1400. The primary difference between the viewers is that in viewer 1600 the windows that form the eyepieces are formed in the side of container 1302 differently to allow viewing of a stereo-image pair in which one image is positioned above the other. In viewer 1600, substantially planar optically transparent windows 1602 and 1604 are formed in the sidewall on diametrically opposite sides of container 1302 and, similarly, substantially planar optically transparent windows 1606 and 1608 are formed in the sidewall on diametrically opposite sides of the container. In the illustrated orientation, the optical vertices of the individual eyepieces do not point toward or away from the sagittal plane, but instead point radially away from an axis of container 302 in different directions 180° opposite each other—that is, upwards and downwards corresponding to left-eye perspective image placement, and right-eye perspective image placement for each eye, meaning that the illustrated embodiment is suitable for viewing stereo-image pairs that are positioned one above the other, as shown in FIG. 17. Images can be displayed with the right-eye-perspective image above the left-eye-perspective image for embodiments having the optical vertex of the left eyepiece pointing in the upwards direction while the optical vertex of the right eyepiece points in the downwards direction, or they can be displayed with the left-eye-perspective image above the right-eye-perspective image for embodiments having the optical vertex of the left eyepiece pointing in the a downwards direction, while the optical vertex of the right eyepiece points in the upwards direction.

The above description of illustrated embodiments, including what is described in the abstract, is not intended to be exhaustive or to limit the invention to the precise forms disclosed. While specific embodiments are described herein for illustrative purposes, various equivalent modifications are possible within the scope of the invention, as those skilled in the relevant art will recognize. These modifications can be made to the invention in light of the above detailed description.

For example, other embodiments of handheld binocular design, wearable eyeglasses, and/or head-mounted visors are within the scope of the invention. Furthermore, a container having the viewing windows and containing dry-goods that can be emptied, or such a container that is for sale empty, to be filled with optically transparent fluids, are also within the scope of invention.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A stereoscopic viewer comprising:
first and second eyepieces spaced apart from each other at a distances substantially corresponding to the distance between human eyes, each eyepiece comprising:
a first window that is planar, optically transparent, and has a first thickness and a first refractive index;
a second window that is planar, optically transparent, and has a second thickness and a second refractive index, the second window positioned opposite the first window at an optical vertex angle relative to the first window; and
a fluid reservoir formed between the first window and a second window and bounded by at least the first window and the second window.

2. The viewer of claim 1, further comprising an optically transparent fluid with a third index of refraction in the fluid reservoir of each eyepiece.

3. The viewer of claim 2 wherein the first and second refractive indices are the same and are different than the third refractive index.

4. The viewer of claim 2 wherein the optically transparent fluid is a liquid, a syrup, or a gel.

5. The viewer of claim 2 wherein the transparent fluid is colorless or colored.

6. The viewer of claim 1, further comprising a fill port fluidly coupled to the fluid reservoir and a cap or plug that can engage with the fill port to hermetically seal the fluid reservoir.

7. The viewer of claim 1 wherein each eyepiece has its own separate fluid reservoir.

8. The viewer of claim 1 wherein both eyepieces share a single fluid reservoir.

9. The viewer of claim 1 wherein an optical vertex of each eyepiece points toward the other eyepiece.

10. The viewer of claim 1 wherein an optical vertex of each eyepiece points away from the other eyepiece.

11. A pair of stereoscopic viewing glasses comprising:
first and second eyepieces spaced apart from each other at a distances substantially corresponding to the distance between human eyes, each eyepiece comprising:
a first window that is planar, optically transparent, and has a first thickness and a first refractive index,
a second window that is planar, optically transparent, and has a second thickness and a second refractive index, the second window positioned opposite the first window at an optical vertex angle relative to the first window, and
a fluid reservoir formed between the first window and a second window and bounded by at least the first window and the second window;
a pair of arms coupled to the first and second eyepieces to engage the ears of a user; and
a cutout between the first and second eyepieces.

12. The glasses of claim 11, further comprising an optically transparent fluid with a third index of refraction in the fluid reservoir of each eyepiece.

13. The glasses of claim 12 wherein the first and second refractive indices are the same and are different than the third refractive index.

14. The glasses of claim 12 wherein the transparent fluid is a liquid, a syrup, or a gel.

15. The glasses of claim 12 wherein the transparent fluid is colorless or colored.

16. The glasses of claim 11, further comprising a fill port fluidly coupled to each fluid reservoir and a cap or plug that can engage with the fill port to hermetically seal the fluid reservoir.

17. The glasses of claim 11 wherein each eyepiece has its own separate fluid reservoir.

18. The glasses of claim 11 wherein both eyepieces share a single fluid reservoir.

19. The glasses of claim 11 wherein an optical vertex of each eyepiece points toward the other eyepiece.

20. The glasses of claim 11 wherein an optical vertex of each eyepiece points away from the other eyepiece.

21. The glasses of claim 11, further comprising a nose pad positioned in the cutout

22. A stereoscopic viewer comprising:
a hermetically sealable fluid container with an interior volume bounded by at least one sidewall and a pair of end structures coupled to the at least one sidewall;
first and second eyepieces spaced apart from each other at a distances substantially corresponding to the distance between human eyes, each eyepiece comprising:
a first window that is planar, optically transparent, and has a first thickness and a first refractive index, the first window being formed in the at least one sidewall;
a second window that is planar, optically transparent, and has a second thickness and a second refractive index, the second window being formed in the sidewall directly opposite the first window and being formed at an optical vertex angle relative to the first window;
wherein the first and second windows and the fluid container form a fluid reservoir between the first and second windows of both eyepieces.

23. The viewer of claim 22, further comprising an optically transparent fluid with a third index of refraction in the fluid reservoir of each eyepiece.

24. The viewer of claim 23 wherein the first and second refractive indices are the same and are different than the third refractive index.

25. The viewer of claim 23 wherein the transparent fluid is a liquid, a syrup, or a gel.

26. The viewer of claim 23 wherein the transparent fluid is colorless or colored.

27. The viewer of claim 22, further comprising a fill port positioned in one of the end structures and fluidly coupled to the fluid reservoir, and a cap or plug that can engage with the fill port to hermetically seal the fluid reservoir.

28. The viewer of claim 22 wherein an optical vertex of each eyepiece points toward the other eyepiece.

29. The viewer of claim 22 wherein an optical vertex of each eyepiece points away from the other eyepiece.

30. The viewer of claim 22 wherein the optical vertex of one eyepiece points in a downwards direction, while the optical vertex of the other eyepiece points in the upwards direction.
